(19) United States
(12) Patent Application Publication
(10) Pub. No.: US 2023/0325457 A1
(43) Pub. Date: Oct. 12, 2023

(54) SYSTEMS AND METHODS FOR PROVIDING FEEDBACK TO WEBPAGE OWNERS

(71) Applicant: Microsoft Technology Licensing, LLC, Redmond, WA (US)

(72) Inventors: Rahul Kumar GUPTA, Hyderabad, Telangana (IN); Pradeep Kumar REDDY K, Hyderabad, Telangana (IN); Bhavesh SHARMA, Hyderabad, Telangana (IN)

(21) Appl. No.: 18/031,829

(22) PCT Filed: Oct. 19, 2021
(86) PCT No.: PCT/US2021/055639

§ 371 Date: Apr. 13, 2023

(30) Foreign Application Priority Data
Oct. 19, 2020 (NL) 2026701

(51) Int. Cl. G06F 16/958

(52) U.S. Cl. CPC G06F 16/958

(57) ABSTRACT

A client device has a browser application to present webpages, accessed via a network, to a user. The client device has a storage device with instructions stored thereon that, when executed by a processor of the client device, cause the client device to present a browser application on a client device display, wherein a graphical user interface (GUI) of the browser application includes a feedback tool and communicate with a server via the network to access a webpage having a page head including webpage metadata. The method further includes identifying a webpage owner contact information from the webpage metadata and, in response to selection of the feedback tool, transmitting feedback information to the webpage owner based on the webpage owner contact information.

### BACKGROUND

### Background and Relevant Art

Feedback on webpage performance and rendering is collected from users through explicit implementation in the code of the webpage. Webpage performance feedback can allow webpage owners and technicians with valuable information on display or function issues for their webpage on different devices, browser applications, connections, or other variations in the way users view the webpage.

### BRIEF SUMMARY

A browser application, according to the present disclosure, provides an implicit feedback tool for webpage feedback. When a webpage fails to load or display properly, a user can provide feedback to the host server regarding the failure. However, when the feedback tool is explicit in the webpage, itself, the failure of the webpage to load can prevent the feedback mechanisms to function, as well. An implicit feedback tool in the browser application allows the browser application to read and/or parse the webpage metadata to identify webpage owner contact information and send feedback directly to the webpage owner without relying on the webpage loading and displaying properly.

In some embodiments, a client device has a browser application to present webpages, accessed via a network, to a user. The client device has a storage device with instructions stored thereon that, when executed by a processor of the client device, cause the client device to present a browser application on a client device display, wherein a graphical user interface (GUI) of the browser application includes a feedback tool and communicate with a server via the network to access a webpage having a page head including webpage metadata. The method further includes identifying a webpage owner contact information from the webpage metadata and, in response to selection of the feedback tool, transmitting feedback information to the webpage owner based on the webpage owner contact information.

This Summary is provided to introduce a selection of concepts in a simplified form that are further described below in the Detailed Description. This Summary is not intended to identify key features or essential features of the claimed subject matter.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a schematic representation of a system for providing feedback to a webpage owner, according to at least some embodiments of the present disclosure;

FIG. 2 is a graphical user interface of a browser application, according to at least some embodiments of the present disclosure;

FIG. 3 is a flowchart illustrating a method of providing feedback to a webpage owner, according to at least some embodiments of the present disclosure;

FIG. 4 is a page head of a webpage that allows for providing feedback to a webpage owner with a compatible browser application, according to at least some embodiments of the present disclosure;

FIG. 5 is a page head of another webpage that allows for providing feedback to a webpage owner with a compatible browser application, according to at least some embodiments of the present disclosure; and

FIG. 6 is a schematic representation of another system for providing feedback to a webpage owner, according to at least some embodiments of the present disclosure.

### DETAILED DESCRIPTION

The present disclosure relates generally to systems and methods for providing feedback on webpage performance. More particularly, the present disclosure related to providing feedback to webpage owners more reliably and easily. In some embodiments, feedback information is provided to the webpage owners through the browser application instead of a frame or field of the webpage itself.

In some embodiments, a browser application is a software application for accessing information the world wide web (i.e., the internet) that is stored and executed locally on a client device. In some embodiments, the browser application is used to present (e.g., display) and interact with a webpage. Because the browser application is stored and executed locally on the client device, a feedback tool can be implemented in the browser application instead of explicitly in the webpage to improve performance of the webpage and increase reliability of sending the feedback information. In some embodiments, moving the feedback tool to the local browser application improves the page load times, decreases page sizes, eliminates the need for custom implementations for feedback tools, reduces loss of feedback information due to operational or loading errors, provides a unified set of templates for screenshots and session details, provides user experience (UX) verifications and fixes, as well as other improvements to the webpage owners and operators.

A browser application (also sometimes called a browser) according to the present disclosure can include a feedback tool that is presented to the user in the graphical user interface (GUI) of the browser application. The feedback tool in the browser application can provide a consistent mechanism by which users can provide feedback to a webpage owner irrespective of the performance of the webpage. For example, if a portion of a webpage loads incorrectly or a portion of the webpage crashes during operation, the function of the feedback tool in the browser application may remain unaffected, whereas webpage based feedback tools may, themselves, fail to operate or load properly.

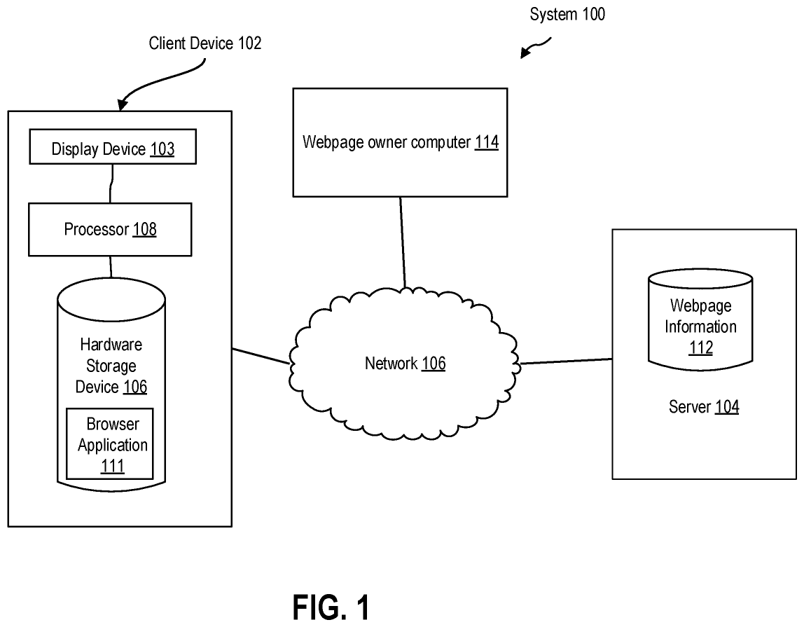

In some embodiments, such as that illustrated in FIG. 1, a system 100 for providing feedback information from a user and/or a client device to a webpage owner includes a client device 102 and server 104 in communication via a network 106. The client device 102 can be any electronic device with an internet connection and configured to execute a browser application to present webpages on the browser application to a user, such as via a display 103. In some embodiments, the client device 102 is a personal mobile device such as a smartphone, a tablet computer, a laptop computer, a desktop computer, a hybrid computer, a wearable electronic device, a household appliance, a vehicle infotainment system, or any other electronic device with an internet browser application loaded thereon.

A client device 102 according to the present disclosure includes a processor 108 and a hardware storage device 110 with the browser application 111 stored thereon. In some embodiments, the processor is a central processing unit (CPU). In some embodiments, the processor 108 is a specialized controller or part of a system on chip (SoC). The processor 108 accesses instructions stored on the hardware storage device 110 and, upon executing the instructions, performs any of the methods described herein.

In some embodiments, the instructions are stored on a non-transient storage medium such as a hardware storage device 110. The hardware storage device 110 may be any type of solid-state memory; volatile memory, such as static random access memory (SRAM) or dynamic random access memory (DRAM); or non-volatile memory, such as read-only memory (ROM) including programmable ROM (PROM), erasable PROM (ERPOM) or EEPROM; magnetic storage media, such as magnetic tape; platen-based storage device, such as hard disk drives; optical media, such as compact discs (CD), digital video discs (DVD), Blu-ray Discs, or other optical media; removable media such as USB drives; non-removable media such as internal SATA or non-volatile memory express (NVMe) style NAND flash memory, or any other non-transient storage media.

The client device 102 further includes a display device 103 on which the browser application 111 and webpage can be displayed to a user. Additionally, the client device includes or is in communication with an input device (such as a keyboard, mouse, touchscreen, etc.) from which the processor 108 and the browser application 111 can receive inputs from the user.

The server 104 can be any remotely accessible computing device that stores webpage information 112 thereon and can provide the webpage information 112 to the client device in response to a request from the client device. In some embodiments, the server 104 is in communication with the client device 102 via a network 106 including one or more connection modalities. For example, the network 106 may include wired connections, cellular connections, Wi-Fi connections, satellite connections, optical connections, any other data connections, or combinations thereof to transmit data between the client device 102 and the server 104.

In some embodiments, the client device 102 is in data communication with a webpage owner computer 114 to transmit feedback information from a feedback tool locally stored on the client device 102 to the webpage owner computer 114. In some embodiments, the client device 102 may transmit the feedback information directly to the webpage owner computer 114. In some embodiments, there is at least one server or computing device of the network 106 located between the client device 102 and the webpage owner computer 114, such as an email server, that acts as an intermediary between the client device 102 and the webpage owner computer 114. In at least one embodiment, the webpage owner computer 114 and the server 104 hosting the webpage information 112 are the same computing device.

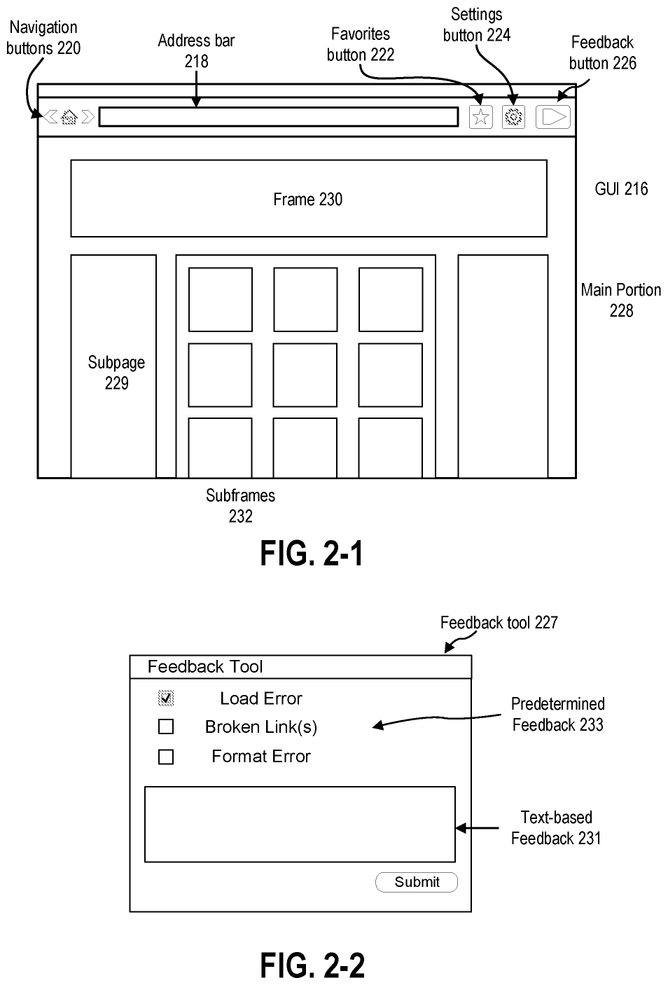

FIG. 2 is an example GUI of a browser application (such as the browser application 111 of FIG. 1). In some embodiments, the browser application stored on and executed by the client device (such as client device 102 of FIG. 1) includes a GUI 216. In some embodiments, the GUI 216 presents elements of the browser application, such as the address bar 218, navigation controls 220, and other buttons to the user. The other buttons can include a favorites button 222, a settings button 224, and, in some embodiments according to the present disclosure, a feedback button 226. In some embodiments, the feedback button 226 is displayed to the user in the main or top-level GUI. In some embodiments, the feedback button 226 is displayed to the user in a submenu or window of the browser application. For example, the feedback button 226 may be included in a nested menu that is displayed to the user upon selecting and/or clicking on the settings button 224. Activating, such as by clicking on, the feedback button 226 executes the feedback tool (e.g., the feedback tool 227 of FIG. 2-2) of the browser application.

The browser application can display a webpage in a main portion 228 of the browser application. In some embodiments, a portion of the webpage is a subpage 229. A subpage is a frame of content on the webpage that not supplied or directly controlled by the webpage owner. In some embodiments, a subpage is a frame containing an advertisement. The content of a banner ad, for example, is commonly not provided or controlled by the webpage owner. Rather the frame space is used to generate revenue from a third party. In other embodiments, a subpage may be a news ticket or other dynamically updating content that is not provided or controlled by the webpage owner.

In some embodiments, the webpage includes various frames 230 or subframes 232 that are laid out in a predetermined format according to the webpage information. The frames 230 contain information that can be presented to the user. In some embodiments, the information is presented visually to a user, such as via text, pictures, or video. In some embodiments, the information is presented to user via audio played in response to clicking on an element or upon loading the webpage in the browser application.

In some instances, the information in a frame 230 or the layout of the webpage does not load properly, resulting in an ineffective communication of information to the user. In conventional webpages, loading or display errors in the frames 230 or layout prevents the use of explicit feedback tools within the webpage.

FIG. 2-2 is a GUI of a feedback tool 227, such as may be launched by the feedback button 226 of FIG. 2-1. The feedback tool 227 can receive inputs from a user for text-based feedback 231 or predetermined feedback 233. In some embodiments, the feedback tool 227 collects feedback information automatically from the client device and/or the network. In some embodiments, the feedback tool 227 automatically populates one or more fields of the feedback tool 227 GUI for the user.

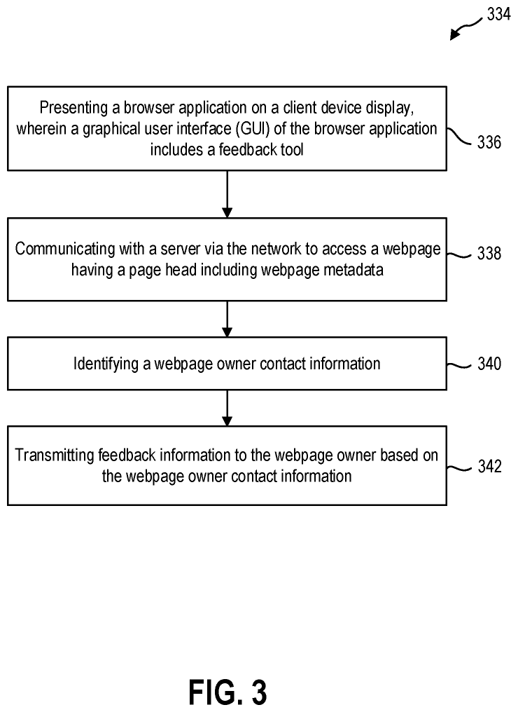

FIG. 3 is a flowchart depicting an embodiment of a method of providing feedback to a webpage owner. In some embodiments, a method 334 of providing feedback to a webpage owner includes presenting the browser application on the client device display, wherein the GUI of the browser application includes the feedback tool (such as the feedback button 226 described in relation to FIG. 2 which activates the feedback tool) independently of the webpage frames and layout at 336. The user can click on the feedback button to activate the feedback tool any time the user identifies something within the webpage frames or layout that is not loading, displaying, or functioning properly. For example, if a picture in a frame fails to display properly, the user can click on the feedback button to activate the feedback tool.

The method further includes communicating with a server via the network to access a webpage having a page head with webpage metadata at 338. In some embodiments, the client device can request the page head of the webpage information, and hence the webpage metadata, in response to a user clicking the feedback button. In some embodiments, the webpage metadata is received upon accessing and loading the webpage information.

In some embodiments, the method includes identifying webpage owner contact information in the webpage metadata at 340 and transmitting feedback information to the webpage owner based on the webpage owner contact information at 342. A given website may have a plurality of webpages. The website is associated with the domain name and each of the plurality of webpages have distinct file paths within the domain.

In some embodiments, the webpage includes one or more subpages and the owner contact information includes subpage owner contact information. A subpage is a frame of content on the webpage that not supplied or directly controlled by the webpage owner. In some embodiments, a subpage is a frame containing an advertisement. The content of a banner ad, for example, is commonly not provided or controlled by the webpage owner. Rather the frame space is used to generate revenue from a third party. In other embodiments, a subpage may be a news ticket or other dynamically updating content that is not provided or controlled by the webpage owner. In some embodiments, the feedback tool can identify subpage owner contact information and can provide feedback information to the subpage owner in the event that the issue or error with the webpage is related to or includes the subpage.

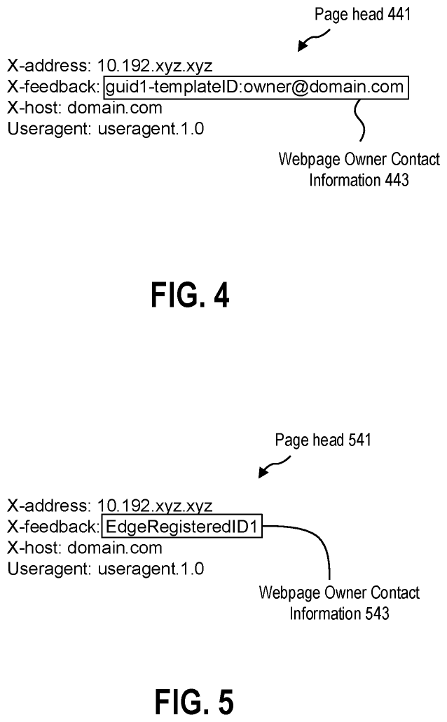

The client device can identify the webpage owner contact information in various ways. In some embodiments, identifying the webpage owner contact information includes reading the webpage owner contact information from the webpage metadata. In some embodiments, the webpage owner contact information 443 is available in the page head 441 of the metadata, such as in the example shown in FIG. 4. The method may include parsing the page head or other parts of the webpage information to identify the webpage owner contact information. In some embodiments, the webpage owner can include a specific string that is recognized by a parsing engine as indicating the location of the webpage owner contact information in the metadata. In some embodiments, the webpage owner contact information includes an Agent ID, an email address, a domain name, other contact information, or combinations thereof.

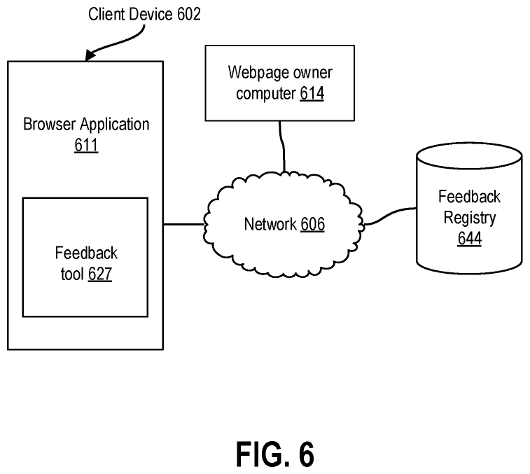

In some embodiments, the webpage owner contact information 543 in the metadata includes a Registry ID that correlates to a webpage owner registry, such as in the example page head 541 in FIG. 5. The webpage owner registry is a registry of known webpage owners that are associated with the browser application or a general registry of known webpage owners. For example, the webpage owner registry may be specific to a particular browser application, such as Microsoft Edge, Google Chrome, or Apple Safari. In other examples, the webpage owner registry may be a public registry that is accessible from a variety of browser applications. In at least one embodiment, the webpage owner registry is stored locally in the hardware storage device of the client device. In some embodiments, the webpage owner registry is stored remotely and is accessed by the client device via a network such as shown in FIG. 6.

FIG. 6 illustrates an embodiment of a client device 602 in data communication with a network 606. A feedback tool 627 or the browser application 611 executed by the client device 602 can, via the network 606, access a webpage owner registry 644. The client device 602 can search the webpage owner registry 644 to identify the webpage owner contact information based on a Registry ID obtained from the webpage metadata by feedback tool 648 of the browser application 646. In some embodiments, the feedback tool 648 sends the feedback information to the webpage owner computer 614 based on the webpage owner contact information.

Once the webpage owner contact information is identified, either directly from the webpage metadata or via correlation with a webpage owner registry, the method includes transmitting the feedback information to the webpage owner. In some embodiments, the feedback information is transmitted directly to the webpage owner, such as via email to the webpage owner's email inbox. In some embodiments, the feedback information is provided to an intermediate server that the webpage owner computer may then access to retrieve the feedback information.

The webpage owner contact information can include a variety of information about the webpage owner. In some embodiments, the webpage owner contact information includes an email address for the webpage owner. In some embodiments, the webpage owner contact information includes a domain address. In some embodiments, the webpage owner contact information includes an agent ID.

In some embodiments, the feedback tool may have a plurality of templates in which the feedback information is provided to the webpage owner. The metadata may further include a template ID that allows the webpage owner, via the webpage metadata, to select the template or format in which the feedback information is provided.

When the feedback information is transmitted by the browser application, in some embodiments, the feedback information email or other correspondence is sent from the browser application. This is in contrast to conventional systems in which the feedback is sent from the server hosting the webpage information. As the feedback is likely being sent in response to a loading or execution failure of the webpage, feedback tools that rely upon the server and webpage information that caused the error are more likely to fail when sending the feedback information.

Further, the browser application can send the feedback information directly from the browser application without relying upon the client device's email client. For example, some conventional feedback systems instruct the client device to launch an email application of the client device. However, this requires the user to send the feedback information from the user's personal or professional email address. Sending the feedback information email from the browser application helps anonymize the feedback information. In some embodiments, the browser application can anonymize the feedback information in additional ways.

In some embodiments, the browser application can provide a web address (e.g., URL) to post feedback without including any browser information or user information. In this way, email of any type may be eliminated from providing the feedback information, and the web owner directly takes the feedback via a POST/GET HTTP endpoint.

The feedback information can provide the webpage owner with information regarding the nature of the error, as well as other information, such as the context, location, software, and hardware on which the error occurred. In some embodiments, the feedback information can collect feedback information that is manually input by the user. In some embodiments, the manually input feedback information can be selected from a predetermined list of options, such as checkboxes or drop-down menus, for ease of categorization and quantification by the webpage owner. In some embodiments, the manually input feedback information can include string inputs in text. Open-ended text inputs can provide more detailed feedback information. However, the effectiveness of text feedback information can be limited by language barriers or by ease of evaluation by the webpage owner. In some embodiments, the manually-input feedback information is a combination of text inputs and selections from predetermined options.

In some embodiments, at least a portion of the feedback information is collected automatically upon the user clicking the feedback tool button. In some embodiments, the feedback tool automatically populates fields that the user may subsequently alter or remove for privacy reasons. In some embodiments, the feedback tool may collect feedback information and automatically populate fields that are hidden from the user or otherwise noneditable. Automatically collected feedback information may be more accurate and/or faster, as well as increasing the collection rate of some feedback information that the user may not readily know. For example, the feedback information can include a version number of the browser application. Most users will not know the specific version number of the browser application and, even if the user knows where to find that feedback information, may choose not to bother. Automatically collecting the browser version number and including that feedback information helps the webpage owner by provided context for the error as well as improving the reliability of the feedback information. The webpage owner can then evaluate whether there are errors in the webpage associated with display and/or use of the webpage on certain browser applications and/or versions of that browser application.

In some embodiments, the feedback information includes client device information. The client device information can include a uniquely identifying client device ID. The client device information can include general (i.e., non-unique) information about the hardware of the client device, such as processor information or product ID. The webpage owner can then evaluate whether there are errors in the webpage associated with display and/or use of the webpage on certain devices.

In some embodiments, the feedback information includes client device location information. For example, the client device location information can include an IP address to identify the device's location relative to the network. In some examples, the client device location is a physical location of the client device, such as collected by global positioning satellite (GPS) sensors, cellular network triangulation, wi-fi network triangulation, or by other location methods. The webpage owner can then evaluate whether there are errors in the webpage associated with display and/or use of the webpage on devices in a certain region of the internet or geographic locations.

In some embodiments, the feedback information includes network type information. For example, the network type information can include relevant information regarding the type of network that provides the data connection between the client and server storing the webpage information. In some examples, a cellular (e.g., 3G, LTE, 5G) or satellite data connection may be more prone to packet loss or drop than a fiber optic connection or a cable broadband connection. The webpage owner can then evaluate whether there are errors in the webpage associated with display and/or use of the webpage on client devices on a certain type of connection.

In some embodiments, the feedback information includes network performance information. For example, the network performance information can include latency information, ping speed, upload speeds, download speeds, etc. In some examples, the errors experienced during loading and/or display of the webpage may be related to connection timeouts or poor network performance. The webpage owner can then evaluate whether there are errors in the webpage associated with display and/or use of the webpage over network connections of a certain performance. In some examples, if a portion of the feedback indicates images failing to load and display properly over a slow connection, the webpage owner may reduce the file size of the images to facilitate faster and/or more reliable image displays.

In some embodiments, the feedback information includes client device posture information. For example, the client device posture information can include information related to the way in which a user is operating the client device while viewing the webpage. In some embodiments, the client device is a foldable personal mobile device and the client device may be displaying the webpage across two display devices (i.e., screens). Some older webpages and/or hosting services may not recognize a dual screen format. In other examples, the display for a desktop may be oriented in a portrait orientation instead of the more conventional landscape orientation, which changes proportions of the webpage and the frame sizes or spacings. The webpage owner can then evaluate whether there are errors in the webpage associated with display and/or use of the webpage on devices operated in certain orientations or postures.

In some embodiments, the feedback information includes client device display settings information. For example, the client device display settings information can include color balance, refresh rate, resolution, or other automatic or user-selected settings. In some examples, webpages may not display properly on low resolutions displays. In some examples, the images and elements of the webpage may not display properly with some color balances. The webpage owner can then evaluate whether there are errors in the webpage associated with display and/or use of the webpage on client devices using certain display settings.

In some embodiments, the feedback information includes webpage load status information. For example, the client device location information can include an IP address to identify the device's location relative to the network. In some examples, the client device location is a physical location of the client device, such as collected by global positioning satellite (GPS) sensors, cellular network triangulation, wi-fi network triangulation, or by other location methods. The webpage owner can then evaluate whether there are errors in the webpage associated with display and/or use of the webpage on devices in a certain region of the internet or geographic locations.

In some embodiments, the feedback information includes a response header. For example, feedback information that is sent via the network to the webpage owner computer can include a HTTP header. In some embodiments, the response header can allow the feedback tool of the browser application to collect and include information about the server hosting the webpage information. An HTTP response header primarily enables communicating and responding to user requests received by the server or the website. The response header is used in response to a request generated from the browser application. This request can be received in the form of an HTTP request header to the server. The server can respond back by creating a response header and attaching the requested data with it. In some embodiments, the information embedded with the response header includes the destination IP address, data type, host address, or other requested information.

In some embodiments, the method can include parsing or searching the page head for webpage owner contact information, and, if no webpage owner contact information is identified, the browser application can grey out or otherwise disable the feedback button. Greying out or disabling the feedback button can indicate to the user, visually and functionally, that the feedback tool is not available for the current webpage or subpage.

### INDUSTRIAL APPLICABILITY

The present disclosure relates generally to systems and methods for providing feedback on webpage performance. More particularly, the present disclosure related to providing feedback to webpage owners more reliably and easily. In some embodiments, feedback information is provided to the webpage owners through the browser application instead of a frame or field of the webpage itself.

In some embodiments, a browser application is stored and executed locally on a client device used to display and interact with a webpage. Because the browser application is stored and executed locally on the client device, a feedback tool can be implemented in the browser application instead of explicitly in the webpage to improve performance of the webpage and increase reliability of sending the feedback information. In some embodiments, moving the feedback tool to the local browser application improves the page load times, decreases page sizes, eliminates the need for custom implementations for feedback tools, reduces loss of feedback information due to operational or loading errors, provides a unified set of templates for screenshots and session details, provides user experience (UX) verifications and fixes, as well as other improvements to the webpage owners and operators.

A browser according to the present disclosure can include a feedback tool that is presented to the user in the graphical user interface (GUI) of the browser application. The feedback tool in the browser application can provide a consistent mechanism by which users can provide feedback to a webpage owner irrespective of the performance of the webpage. For example, if a portion of a webpage loads incorrectly or a portion of the webpage crashes during operation, the function of the feedback tool in the browser application may remain unaffected, whereas webpage based feedback tools may, themselves, fail to operate or load properly.

In some embodiments, a system for providing feedback information from a user and/or a client device to a webpage owner includes a client device and server in communication via a network. The client device can be any electronic device with an internet connection and configured to execute a browser application to display webpages on the browser application to a user. In some embodiments, the client device is a personal mobile device such as a smartphone, a tablet computer, a laptop computer, a desktop computer, a hybrid computer, a wearable electronic device, a household appliance, a vehicle infotainment system, or any other electronic device with an internet browser application loaded thereon.

A client device according to the present disclosure includes a processor and a hardware storage device. In some embodiments, the processor is a central processing unit (CPU). In some embodiments, the processor is a specialized controller or part of a system on chip (SoC). The processor accesses instructions stored on the hardware storage device and, upon executing the instructions, performs any of the methods described herein.

In some embodiments, the instructions are stored on a non-transient storage medium such as a hardware storage device. The hardware storage device may be any type of solid-state memory; volatile memory, such as static random access memory (SRAM) or dynamic random access memory (DRAM); or non-volatile memory, such as read-only memory (ROM) including programmable ROM (PROM), erasable PROM (ERPOM) or EEPROM; magnetic storage media, such as magnetic tape; platen-based storage device, such as hard disk drives; optical media, such as compact discs (CD), digital video discs (DVD), Blu-ray Discs, or other optical media; removable media such as USB drives; non-removable media such as internal SATA or non-volatile memory express (NVMe) style NAND flash memory, or any other non-transient storage media.

The client device further includes a display device on which the browser application and webpage can be displayed to a user. Additionally, the client device includes or is in communication with an input device from which the processor and the browser application can receive inputs from the user.

The server can be any remotely accessible computing device that stores webpage information thereon and can provide the webpage information to the client device in response to a request from the client device. In some embodiments, the server is in communication with the client device via a network including one or more connection modalities. For example, the network may include wired connections, cellular connections, Wi-Fi connections, satellite connections, optical connections, any other data connections, or combinations thereof to transmit data between the client device and the server.

In some embodiments, the client device is in data communication with a webpage owner computer to transmit feedback information from a feedback tool locally stored on the client device to the webpage owner computer. In some embodiments, the client device may transmit the feedback information directly to the webpage owner computer. In some embodiments, there is at least one server or computing device of the network located between the client device and the webpage owner computer, such as an email server, that acts as an intermediary between the client device and the webpage owner computer. In at least one embodiment, the webpage owner computer and the server hosting the webpage information are the same computing device.

The browser application stored on and executed by the client device include a GUI. In some embodiments, the GUI presents elements of the browser application, such as the address bar, navigation controls, and other buttons to the user. The other buttons can include a favorites button, a settings button, and, in some embodiments according to the present disclosure, a feedback button. In some embodiments, the feedback button is displayed to the user in the main or top-level GUI. In some embodiments, the feedback button is displayed to the user in a submenu or window of the browser application. For example, the feedback button may be included in a nested menu that is displayed to the user upon selecting and/or clicking on the settings button. Activating, such as by clicking on, the feedback button executes the feedback tool of the browser application.

The browser application can display a webpage in a main portion of the browser application. In some embodiments, a portion of the webpage is a subpage. A subpage is a frame of content on the webpage that not supplied or directly controlled by the webpage owner. In some embodiments, a subpage is a frame containing an advertisement. The content of a banner ad, for example, is commonly not provided or controlled by the webpage owner. Rather the frame space is used to generate revenue from a third party. In other embodiments, a subpage may be a news ticket or other dynamically updating content that is not provided or controlled by the webpage owner.

In some embodiments, the webpage includes various frames or subframes that are laid out in a predetermined format according to the webpage information. The frames contain information that can be presented to the user. In some embodiments, the information is presented visually to a user, such as via text, pictures, or video. In some embodiments, the information is presented to user via audio played in response to clicking on an element or upon loading the webpage in the browser application.

In some instances, the information in a frame or the layout of the webpage does not load properly, resulting in an ineffective communication of information to the user. In conventional webpages, loading or display errors in the frames or layout prevents the use of explicit feedback tools within the webpage. In some embodiments, a method of providing feedback to a webpage owner includes presenting the browser application on the client device display, wherein the GUI of the browser application includes the feedback tool (e.g., the feedback button which activates the feedback tool) independently of the webpage frames and layout. The user can click on the feedback button to activate the feedback tool anytime the user identifies something within the webpage frames or layout that is not loading, displaying, or functioning properly. For example, if a picture in a frame fails to display properly, the user can click on the feedback button to activate the feedback tool.

The method further includes communicating with a server via the network to access a webpage having a page head with webpage metadata. In some embodiments, the client device can request the page head of the webpage information, and hence the webpage metadata, in response to a user clicking the feedback button. In some embodiments, the webpage metadata is received upon accessing and loading the webpage information.

In some embodiments, the method includes identifying webpage owner contact information in the webpage metadata and transmitting feedback information to the webpage owner based on the webpage owner contact information. In some embodiments, the webpage includes one or more subpages and the owner contact information includes subpage owner contact information. A subpage is a frame of content on the webpage that not supplied or directly controlled by the webpage owner. In some embodiments, a subpage is a frame containing an advertisement. The content of a banner ad, for example, is commonly not provided or controlled by the webpage owner. Rather the frame space is used to generate revenue from a third party. In other embodiments, a subpage may be a news ticket or other dynamically updating content that is not provided or controlled by the webpage owner. In some embodiments, the feedback tool can identify subpage owner contact information and can provide feedback information to the subpage owner in the event that the issue or error with the webpage is related to or includes the subpage

The client device can identify the webpage owner contact information in various ways. In some embodiments, identifying the webpage owner contact information includes reading the webpage owner contact information from the webpage metadata. In some embodiments, the webpage owner contact information is available in the page head of the metadata. The method may include parsing the page head or other parts of the webpage information to identify the webpage owner contact information. In some embodiments, the webpage owner can include a specific string that is recognized by a parsing engine as indicating the location of the webpage owner contact information in the metadata.

In some embodiments, the webpage owner contact information in the metadata includes a Registry ID that correlates to a webpage owner registry. The webpage owner registry is a registry of known webpage owners that are associated with the browser application or a general registry of known webpage owners. For example, the webpage owner registry may be specific to a particular browser application, such as Microsoft Edge, Google Chrome, or Apple Safari. In other examples, the webpage owner registry may be a public registry that is accessible from a variety of browser applications. In at least one embodiment, the webpage owner registry is stored locally in the hardware storage device of the client device. In some embodiments, the webpage owner registry is stored remotely and is accessed by the client device via a network.

Once the webpage owner contact information is identified, either directly from the webpage metadata or via correlation with a webpage owner registry, the method includes transmitting the feedback information to the webpage owner. In some embodiments, the feedback information is transmitted directly to the webpage owner, such as via email to the webpage owner's email inbox. In some embodiments, the feedback information is provided to an intermediate server that the webpage owner computer may then access to retrieve the feedback information.

The webpage owner contact information can include a variety of information about the webpage owner. In some embodiments, the webpage owner contact information includes an email address for the webpage owner. In some embodiments, the webpage owner contact information includes a domain address. In some embodiments, the webpage owner contact information includes an agent ID.

In some embodiments, the feedback tool may have a plurality of templates in which the feedback information is provided to the webpage owner. The metadata may further include a template ID that allows the webpage owner, via the webpage metadata, to select the template or format in which the feedback information is provided.

When the feedback information is transmitted by the browser application, in some embodiments, the feedback information email or other correspondence is sent from the browser application. This is in contrast to conventional systems in which the feedback is sent from the server hosting the webpage information. As the feedback is likely being sent in response to a loading or execution failure of the webpage, feedback tools that rely upon the server and webpage information that caused the error are more likely to fail when sending the feedback information.

Further, the browser application can send the feedback information directly from the browser application without relying upon the client device's email client. For example, some conventional feedback systems instruct the client device to launch an email application of the client device. However, this requires the user to send the feedback information from the user's personal or professional email address. Sending the feedback information email from the browser application helps anonymize the feedback information. In some embodiments, the browser application can anonymize the feedback information in additional ways.

In some embodiments, the browser application can provide a web address (e.g., URL) to post feedback without including any browser information or user information. In this way, email of any type may be eliminated from providing the feedback information, and the web owner directly takes the feedback via a POST/GET HTTP endpoint.

The feedback information can provide the webpage owner with information regarding the nature of the error, as well as other information, such as the context, location, software, and hardware on which the error occurred. In some embodiments, the feedback information can collect feedback information that is manually input by the user. In some embodiments, the manually input feedback information can be selected from a predetermined list of options, such as checkboxes or drop-down menus, for ease of categorization and quantification by the webpage owner. In some embodiments, the manually input feedback information can include string inputs in text. Open-ended text inputs can provide more detailed feedback information. However, the effectiveness of text feedback information can be limited by language barriers or by ease of evaluation by the webpage owner. In some embodiments, the manually-input feedback information is a combination of text inputs and selections from predetermined options.

In some embodiments, at least a portion of the feedback information is collected automatically upon the user clicking the feedback tool button. In some embodiments, the feedback tool automatically populates fields that the user may subsequently alter or remove for privacy reasons. In some embodiments, the feedback tool may collect feedback information and automatically populate fields that are hidden from the user or otherwise noneditable. Automatically collected feedback information may be more accurate and/or faster, as well as increasing the collection rate of some feedback information that the user may not readily know. For example, the feedback information can include a version number of the browser application. Most users will not know the specific version number of the browser application and, even if the user knows where to find that feedback information, may choose not to bother. Automatically collecting the browser version number and including that feedback information helps the webpage owner by provided context for the error as well as improving the reliability of the feedback information. The webpage owner can then evaluate whether there are errors in the webpage associated with display and/or use of the webpage on certain browser applications and/or versions of that browser application.

In some embodiments, the feedback information includes client device information. The client device information can include a uniquely identifying client device ID. The client device information can include general (i.e., non-unique) information about the hardware of the client device, such as processor information or product ID. The webpage owner can then evaluate whether there are errors in the webpage associated with display and/or use of the webpage on certain devices.

In some embodiments, the feedback information includes client device location information. For example, the client device location information can include an IP address to identify the device's location relative to the network. In some examples, the client device location is a physical location of the client device, such as collected by global positioning satellite (GPS) sensors, cellular network triangulation, wi-fi network triangulation, or by other location methods. The webpage owner can then evaluate whether there are errors in the webpage associated with display and/or use of the webpage on devices in a certain region of the internet or geographic locations.

In some embodiments, the feedback information includes network type information. For example, the network type information can include relevant information regarding the type of network that provides the data connection between the client and server storing the webpage information. In some examples, a cellular (e.g., 3G, LTE, 5G) or satellite data connection may be more prone to packet loss or drop than a fiber optic connection or a cable broadband connection. The webpage owner can then evaluate whether there are errors in the webpage associated with display and/or use of the webpage on client devices on a certain type of connection.

In some embodiments, the feedback information includes network performance information. For example, the network performance information can include latency information, ping speed, upload speeds, download speeds, etc. In some examples, the errors experienced during loading and/or display of the webpage may be related to connection timeouts or poor network performance. The webpage owner can then evaluate whether there are errors in the webpage associated with display and/or use of the webpage over network connections of a certain performance. In some examples, if a portion of the feedback indicates images failing to load and display properly over a slow connection, the webpage owner may reduce the file size of the images to facilitate faster and/or more reliable image displays.

In some embodiments, the feedback information includes client device posture information. For example, the client device posture information can include information related to the way in which a user is operating the client device while viewing the webpage. In some embodiments, the client device is a foldable personal mobile device and the client device may be displaying the webpage across two display devices (i.e., screens). Some older webpages and/or hosting services may not recognize a dual screen format. In other examples, the display for a desktop may be oriented in a portrait orientation instead of the more conventional landscape orientation, which changes proportions of the webpage and the frame sizes or spacings. The webpage owner can then evaluate whether there are errors in the webpage associated with display and/or use of the webpage on devices operated in certain orientations or postures.

In some embodiments, the feedback information includes client device display settings information. For example, the client device display settings information can include color balance, refresh rate, resolution, or other automatic or user-selected settings. In some examples, webpages may not display properly on low resolutions displays. In some examples, the images and elements of the webpage may not display properly with some color balances. The webpage owner can then evaluate whether there are errors in the webpage associated with display and/or use of the webpage on client devices using certain display settings.

In some embodiments, the feedback information includes webpage load status information. For example, the client device location information can include an IP address to identify the device's location relative to the network. In some examples, the client device location is a physical location of the client device, such as collected by global positioning satellite (GPS) sensors, cellular network triangulation, wi-fi network triangulation, or by other location methods. The webpage owner can then evaluate whether there are errors in the webpage associated with display and/or use of the webpage on devices in a certain region of the internet or geographic locations.

In some embodiments, the feedback information includes a response header. For example, feedback information that is sent via the network to the webpage owner computer can include a HTTP header. In some embodiments, the response header can allow the feedback tool of the browser application to collect and include information about the server hosting the webpage information. An HTTP response header primarily enables communicating and responding to user requests received by the server or the website. The response header is used in response to a request generated from the browser application. This request can be received in the form of an HTTP request header to the server. The server can respond back by creating a response header and attaching the requested data with it. In some embodiments, the information embedded with the response header includes the destination IP address, data type, host address, or other requested information.

In some embodiments, the method can include parsing or searching the page head for webpage owner contact information, and, if no webpage owner contact information is identified, the browser application can grey out or otherwise disable the feedback button. Greying out or disabling the feedback button can indicate to the user, visually and functionally, that the feedback tool is not available for the current webpage or subpage.

The present disclosure relates to systems and methods for feedback information to a webpage owner according to at least the examples provided in the sections below:

(A1) In one aspect, some embodiments include a method of providing feedback information to a webpage owner. The method is performed at a client device (e.g., 102) in data communication with a network (e.g., 106). The method includes: (i) presenting (e.g., act 336) a browser application on the client device display, where a graphical user interface (GUI) of the browser application includes a feedback tool (e.g., feedback button 226); (ii) communicating (e.g., act 338) with a server (e.g., 104) via the network to access a webpage having a page head (e.g., 441, 541) including webpage metadata; (iii) identifying (e.g., act 340) a webpage owner contact information (443, 543) from the webpage metadata; and (iv) in response to selection of the feedback tool, transmitting (e.g., act 342) feedback information (e.g., 231, 233) to the webpage owner based on the webpage owner contact information.

(A2) In some embodiments of A1, the webpage metadata includes a webpage owner email address (e.g., as illustrated in FIG. 4).

(A3) In some embodiments of any of A1-A2, the webpage metadata includes a webpage owner domain (e.g., as illustrated in FIG. 5).

(A4) In some embodiments of A1-A3, the webpage metadata includes an agent ID (e.g., useragent. 1.0 in FIG. 5).

(A5) In some embodiments of A1-A4: (i) the webpage metadata includes a registry ID; and (ii) the method further includes: (a) accessing a webpage owner registry (e.g., registry 644), and (b) identifying the webpage owner contact information in the webpage owner registry based upon the registry ID.

(A6) In some embodiments of A1-A5, the feedback information is provided by a user via an input device (e.g., via a keyboard, mouse, or touch surface).

(A7) In some embodiments of A1-A6, the feedback information includes browser application version information.

(A8) In some embodiments of A1-A7, the feedback information includes client device posture information (e.g., indicating landscape or portrait mode).

(A9) In some embodiments of A1-A8, identifying the webpage owner contact information includes parsing the webpage metadata. Parsing the webpage metadata can allow the feedback tool to identify webpage owner contact information in the metadata without explicit tags and/or without user intervention.

(A10) In some embodiments of A1-A9, the method further includes receiving feedback information with the feedback tool of the browser application.

(A11) In some embodiments of A1-A10, the feedback information includes network performance information. Some embodiments of the present method allow for the collection of information that a user may not have immediately available or may lack experience to provide. For example, the feedback tool collecting network performance information (automatically or at a user's request), can quantify network performance in manner that most users cannot.

(A12) In some embodiments of A1-A11, the feedback information includes client device location information. The feedback information can include client device location information to provide the webpage owner location and/or geographic context for the feedback information regarding the error.

(A13) In some embodiments of A1-A12, the feedback information includes page loading success information. In some instances, the user may initiate feedback for a webpage because the webpage does not function how they expect. Page loading success information can indicate whether the missing functionality is related to a hardware or software issue of the client device, or whether the webpage information did not fully reach the client device via the network.

(A14) In some embodiments of A1-A13, the method further includes anonymizing the feedback information (e.g., removing any personally identifying information of the user).

(A15) In some embodiments of A1-A14, the method further includes disabling the feedback tool in the GUI when website owner contact information is unavailable.

(A16) In some embodiments of A1-A15, the feedback information includes response headers.

(A17) In some embodiments of A1-A16, the webpage owner contact information includes subpage owner contact information.

(A18) In some embodiments of A1-A17: (i) the webpage includes a first section (e.g., main portion 228) and a second section (e.g., frame 230 or a subframe 232), the first section having a first owner and the second section having a second owner, distinct from the first owner; (ii) identifying the webpage owner contact information includes identifying contact information for the first owner and the second owner; and (iii) the method further includes, in response to selection of the feedback tool: (a) identifying whether the feedback is for the first section, the second section, or both; (b) in accordance with the feedback being for the first section, transmitting feedback information to the first owner based on the webpage owner contact information and forgoing transmitting the feedback information to the second owner; (c) in accordance with the feedback being for the second section, transmitting the feedback information to the second owner based on the webpage owner contact information and forgoing transmitting the feedback information to the first owner; and (d) in accordance with the feedback being for both the first section and the second section, transmitting the feedback information to the first owner and the second owner.

(A19) In some embodiments of A18, identifying whether the feedback is for the first section, the second section, or both includes enabling the user to identify the section(s) for feedback. In some embodiments, the device presents the user with a list of sections for the webpage and receives a user selection of the section(s) for feedback. In some embodiments, the device requests that the user identify the section(s) and receives the user identification via an input device (e.g., the user indicates the sections with a mouse or touch surface). In some embodiments, the device identifies the section(s) automatically based on error(s) loading the webpage (e.g., time-out errors for particular sections). In some embodiments, the device suggests sections to the user based on error(s) loading the webpage.

In another aspect, some embodiments include a client device (e.g., 102) having (i) a processor (e.g., 108); (ii) a display device; (iii) an input device; and (iv) a hardware storage device (e.g., 110) in data communication with the processor, the hardware storage device having instructions stored thereon that, when executed by the processor, cause the processor to perform any method described herein (e.g., any of methods A1-A19).

In yet another aspect, some embodiments include a device or system configured to perform any method described or depicted herein (e.g., any of methods A1-A19).

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the scope of the present disclosure, and that various changes, substitutions, and alterations may be made to embodiments disclosed herein without departing from the scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

It should be understood that any directions or reference frames in the preceding description are merely relative directions or movements. For example, any references to “front” and “back” or “top” and “bottom” or “left” and “right” are merely descriptive of the relative position or movement of the related elements.

The present disclosure may be embodied in other specific forms without departing from its characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. A method of providing information to a webpage owner, the method comprising:
at a client device, where the client device is in data communication with a network:
presenting a browser application on a client device display, wherein a graphical user interface (GUI) of the browser application includes a feedback tool;
communicating with a server via the network to access a webpage having a page head including webpage metadata;
identifying a webpage owner contact information from the webpage metadata; and
in response to selection of the feedback tool, transmitting feedback information to the webpage owner based on the webpage owner contact information.

2. The method of claim 1, wherein the webpage metadata includes a webpage owner email address.

3. The method of claim 1, wherein the webpage metadata includes a webpage owner domain.

4. The method of claim 1, wherein the webpage metadata includes an agent ID.

5. The method of claim 1, wherein the webpage metadata includes a registry ID; and
the method further includes:
accessing a webpage owner registry, and
identifying the webpage owner contact information in the webpage owner registry based upon the registry ID.

6. The method of claim 1, wherein at least a portion of the feedback information is provided by a user of the client device.

7. The method of claim 1, wherein the feedback information includes browser application version information.

8. The method of claim 1, wherein the feedback information includes client device posture information.

9. The method of claim 1, wherein identifying the webpage owner contact information includes parsing the webpage metadata.

10. The method of claim 1, further comprising receiving feedback information as a text input with the feedback tool.

11. The method of claim 1, wherein the feedback information includes network performance information.

12. The method of claim 1, wherein the feedback information includes client device location information.

13. The method of claim 1, wherein the feedback information includes page loading success information.

14. The method of claim 1, wherein the webpage includes a first section and a second section, the first section having a first owner and the second section having a second owner, distinct from the first owner;
wherein identifying the webpage owner contact information comprises identifying contact information for the first owner and the second owner; and
the method further comprises, in response to selection of the feedback tool:
identifying whether the feedback is for the first section, the second section, or both;
in accordance with the feedback being for the first section, transmitting feedback information to the first owner based on the webpage owner contact information and forgoing transmitting the feedback information to the second owner;
in accordance with the feedback being for the second section, transmitting the feedback information to the second owner based on the webpage owner contact information and forgoing transmitting the feedback information to the first owner; and
in accordance with the feedback being for both the first section and the second section, transmitting the feedback information to the first owner and the second owner.

15. A client device comprising:
a processor;
a display device;
an input device; and
a hardware storage device in data communication with the processor, the hardware storage device having instructions stored thereon that, when executed by the processor, cause the processor to:
present a browser application on a client device display, wherein a graphical user interface (GUI) of the browser application includes a feedback tool;
communicate with a server via the network to access a webpage having a page head including webpage metadata;
identify a webpage owner contact information from the webpage metadata; and
in response to selection of the feedback tool, transmit feedback information to the webpage owner based on the webpage owner contact information.
